(19) United States
(12) Patent Application Publication
(10) Pub. No.: US 2024/0278590 A1
(43) Pub. Date: Aug. 22, 2024

(54) METHOD FOR DECORATING A MOBILE DEVICE CASE

(71) Applicant: PopSockets LLC, Boulder, CO (US)

(72) Inventors: David B. Barnett, Boulder, CO (US); Altan Nahum, Boulder, CO (US)

(21) Appl. No.: 18/583,594

(22) Filed: Feb. 21, 2024

Related U.S. Application Data
(60) Provisional application No. 63/447,161, filed on Feb. 21, 2023.

(51) Int. Cl. B41M 5/00; B41J 3/407; B41J 11/00

(52) U.S. Cl. CPC B41M 5/0047; B41J 3/4073; B41J 11/00214

(57) ABSTRACT

A method for producing a decorative mobile device case includes uploading a graphic image to a digital printing software application and defining at least one opacity enhancing layer using said digital printing application. The method may also include forming, using said digital printing application, a composite image comprised of said graphic image and said at least one opacity enhancing layer. At least one ink layer is then deposited on a first side of a transparent substrate, wherein the at least one ink layer corresponds to the composite image. Finally after depositing the at least one ink layer, the method includes either inserting the transparent substrate between a mobile electronic device and a mobile device case, or attaching the first side of the transparent substrate to an exterior of the decorative mobile device case.

### CROSS-REFERENCE TO RELATED APPLICATIONS

This application claims the benefit of U.S. Provisional Application No. 63/447,161, filed on Feb. 21, 2023.

### FIELD OF THE DISCLOSURE

The present disclosure generally relates to decorating a case of a mobile device, and more particularly to a method for decorating a mobile device case using a digital printing process.

### BACKGROUND

Mobile devices, such as mobile phones, are often housed in cases to provide additional protection. However, such cases can appear identical or nearly identical to other cases. Even when the cases are decorative, there is currently no practical way to change the look of the case, meaning that users have to buy a new case when they want to change the appearance of their mobile device.

There are known ways of decorating mobile device cases, such as ultraviolet (UV) inkjet digital printing. The UV digital printing process involves tiny ink droplets being propelled onto a surface of a substrate before being cured by a UV light. The process generally involves applying a 2D digital image to a 3D object. A UV inkjet printer propels tiny droplets of ink onto paper, plastic, glass, metal and other substrates in order to form an image through the use of an ink delivery system, also known as a print head. The image is sent to the printer digitally (through the use of a computer) and is an exact representation of the digital image.

While UV inkjet digital printing has been used to either directly print on a mobile-device case backside, the resultant printed images look grainy and rough due to the texture of the collection of ink droplets. Thus, there is a need for a method to allow consumers to customize or personalize their mobile device cases using a process that does not suffer from the drawbacks of prior art approaches.

### SUMMARY OF THE INVENTION

The present disclosure relates to a method for producing a decorative mobile device case. In one or more embodiments, the method for producing a decorative mobile device case includes uploading a graphic image to a digital printing software application. The method also includes depositing at least one ink layer on a first side of a transparent substrate, wherein the at least one ink layer corresponds to the digital image. After depositing the at least one ink layer, the method further includes either inserting the transparent substrate between a mobile electronic device and the decorative mobile device case, or attaching the first side of the transparent substrate to an exterior of the decorative mobile device case.

In one or more embodiments, the method for producing a decorative mobile device case includes uploading a graphic image to a digital printing software application, and forming a reverse of the digital image using said digital image software application. The method also includes depositing, after forming the reverse digital image, at least one ink layer on a first side of a transparent substrate, wherein the at least one ink layer corresponds to the reverse digital image. After depositing the at least one ink layer, the method further includes either inserting the transparent substrate between a mobile electronic device and the decorative mobile device case, or attaching the first side of the transparent substrate to an exterior of the decorative mobile device case.

In one or more embodiments, the method includes uploading a graphic image to a digital printing software application and defining at least one white layer using said digital printing application. The method also comprises forming, using said digital printing application, a composite image comprised of said graphic image and said at least one white layer. At least one ink layer is then deposited on a first side of a transparent substrate, wherein the at least one ink layer corresponds to the composite image. Finally after depositing the at least one ink layer, the method includes either inserting the transparent substrate between a mobile electronic device and a mobile device case, or attaching the first side of the transparent substrate to an exterior of the decorative mobile device case.

### BRIEF DESCRIPTION OF THE DRAWINGS

FIG. 1 is an exploded view of an insert card, a graphic ink layer, and a mobile device case configured in accordance with the principles of the invention;

FIG. 2 depicts a front view of the insert card of FIG. 1 shown with a graphic ink layer applied to the mobile-device-side of the insert card, in accordance with the principles of the invention;

FIG. 3 is an exploded view of the arrangement of FIG. 1 with the addition of an optional opacity enhancing layer, in accordance with the principles of the invention; and

FIG. 4 is one embodiment of a method for decorating a mobile device case in accordance with the principles of the invention.

### DETAILED DESCRIPTION

One aspect of the present disclosure relates to a method for decorating mobile-device cases by means of a printing process that produces images that look smooth and crisp, and therefore the produced images do not suffer from the drawbacks of prior-art versions of the process. In one or more embodiments, an image is digitally printed on the interior (i.e., mobile-device side) of a transparent plastic insert card. Optionally, an opacity enhancing layer (e.g., layer of white ink) may be applied on top of the image in order to further improve graphics opacity and definition when printing on transparent substrates. Such a layer improves graphics opacity and definition regardless of the color of the mobile device that may be behind the transparent substrate. For example, when underprinting, a white ink layer may be applied over all areas receiving graphics ink. In addition, the white ink layer may further extend slightly outside the areas receiving graphics ink. While the disclosure below may generally refer to a white ink layer as being the opacity enhancing layer, it should be appreciated that in other embodiments the opacity enhancing layer may be a white or solid color ink, paint, or primer layer.

In one or more embodiments a UV inkjet digital printing process is used. In such embodiments, when the UV ink droplets make contact with the transparent plastic insert card, they are forced (e.g., by the force generated when spraying the ink droplets onto the insert card) to compress against the surface of the insert card to jointly conform to the flat surface of the card, thereby forming a layer of ink that is smooth on the card-side of the layer. In particular, this is in contrast to the side of the layer opposite the card, which remains relatively rough, comprising relatively large peaks and troughs. The result is an image that has a smooth and crisp appearance when viewed through the transparent insert card from the side of the card opposite the ink layer.

It should further be appreciated that the graphic ink layer and opacity enhancing layer may be applied to the undersurface of the insert card using various means, including spray, ink jet, UV inkjet, offset lithography, flexography, and pad printing. Alternatively, the graphic ink layer and opacity enhancing layer may be laminated to or adhered to the insert card using pre-decorated laminate films. Further, non-additive based means of insert card decoration may be used, such as laser etching.

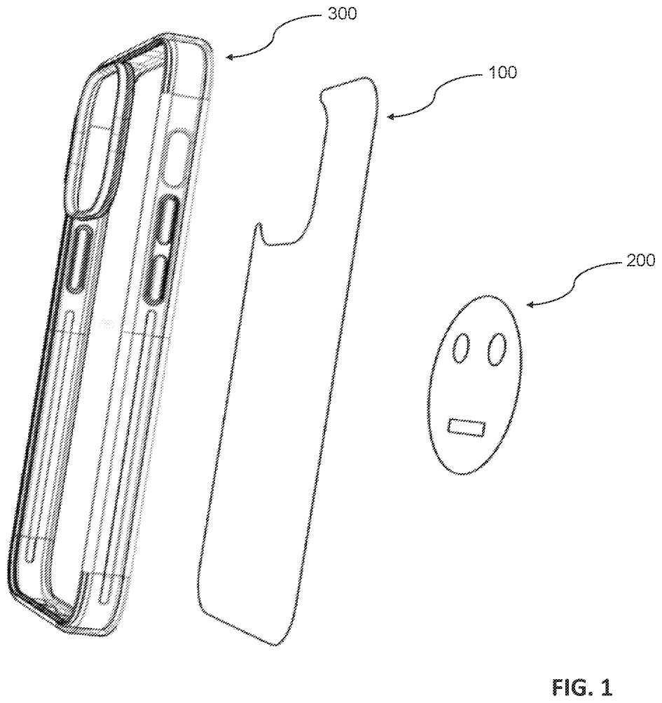

Referring now to the figures, FIG. 1 is an exploded view of a transparent insert card 100, a graphic ink layer 200 to be applied to the insert card 100, and a mobile device case 300. In one or more embodiments, the transparent insert card 100 is a clear substrate material, such as plastic or treated glass. Moreover, the graphic ink layer 200 corresponds to a desired image to be printed onto the transparent insert card 100.

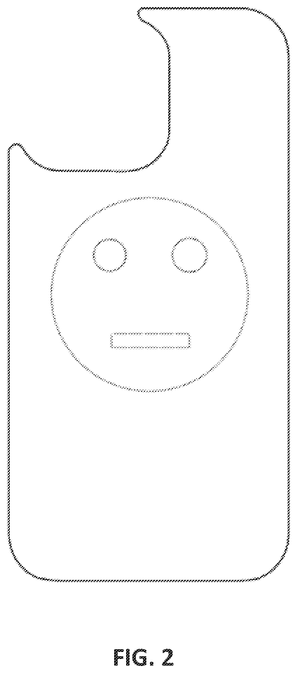

FIG. 2 depicts a front view of the insert card 100 of FIG. 1, shown with the graphic ink layer 200 having been applied to the interior (i.e., mobile device side) of the transparent insert 100.

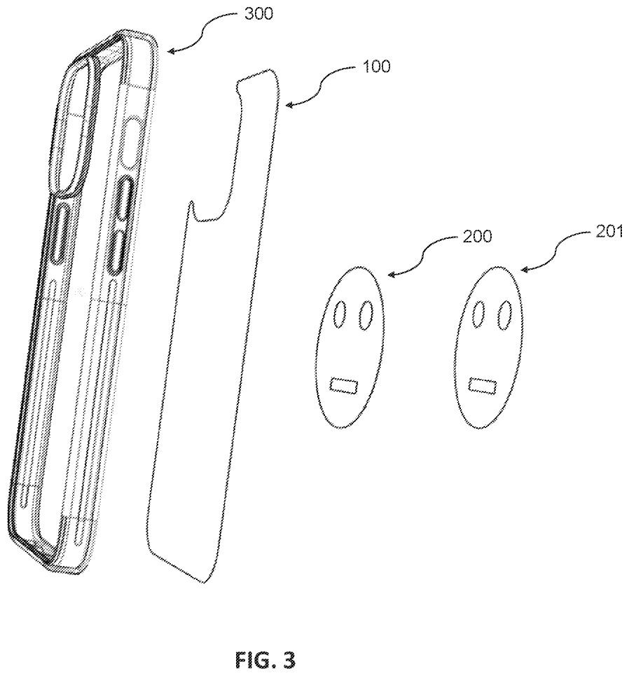

Moreover, FIG. 3 depicts an exploded view of the insert card 100, graphic ink layer 200, and case 300 of FIGS. 1-2. In addition, FIG. 3 depicts the aforementioned opacity enhancing layer 201, which in one embodiment may comprise a white ink layer.

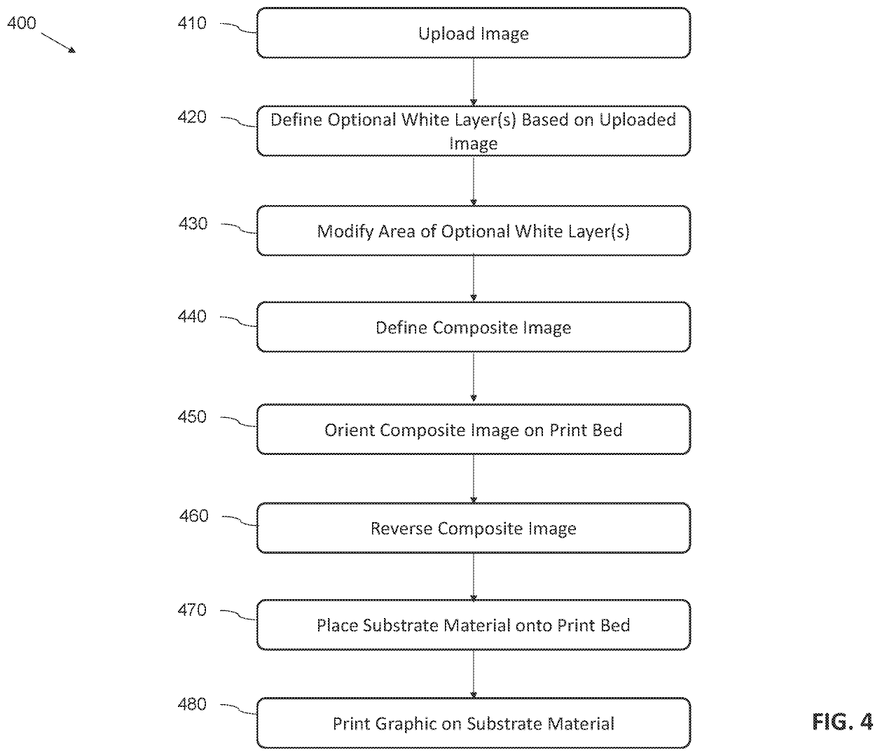

Referring now to FIG. 4, depicted is one embodiment of a method of producing a decorative mobile device case in accordance with the principles of the invention. In particular, method 400 comprises uploading the desired graphic image to a software application for the selected printing process, which in some embodiments may comprise the digital transfer of the image file to a software pre-processing and raster image processing application (block 410). Thereafter, at block 420 the software application may be used to create one or two white layers that will overlay the uploaded graphic image. In an embodiment, at block 420 the software application may be used to create one or two white layers to selectively overlay the areas of the graphic image where it is desirable to improve graphic image opacity, leaving ink translucent the remaining areas of the graphic image.

At block 430, each of the one or two white layers may be thinned (border area reduced) by approximately 4 pixels (approx. 0.15 mm) as compared to the area of the uploaded graphic image.

At block 440, the software application may then be used to define a composite image of the two or three layers (e.g., 1 color graphic layer plus 1 or 2 white layers). In a preferred embodiment, the color graphic layer is positioned as the bottom-most layer of the composite so that it is printed first and the white layer(s) are the middle and top layers (when two white layers are used).

Then, at block 450, the composite image is oriented on the print bed. A “reverse” of the image may then be generated at block 460 such that a mirror image of the composite graphic is created. Thereafter, a clear sheet substrate material is placed onto the print bed (block 470), followed by the software application being used to execute the print operation at block 480 whereby all layers are printed, with the color graphic being printed first, directly onto the clear sheet substrate, followed by the one or two white layers being printed thereon. Upon completion, the color graphic is viewable from the opposite side of the clear sheet in a smooth and clear fashion, thereby forming a decorative insert card. At that point, one or more decorative insert cards may be arranged between the mobile electronic device and the case (e.g., mobile device case 300). In an additional embodiment, the decorative insert card 100 may be attached to the exterior of the case or to a bumper of the case forming at least a portion of the back of the case, by snap fit, mechanical binding, magnetic coupling, adhesive substrate, or a combination thereof, with the graphic and optional white layers located on the undersurface of insert card 100 (e.g., such that the smooth side of the graphic is visible through the transparent insert card from an exterior perspective). It will be appreciated that one or more software applications may be used to perform the method steps at blocks 410 through 460, and the order of certain processing steps may be altered without affecting the composite graphic created.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of various embodiments. This description should be read to include one or at least one and the singular also includes the plural unless it is obvious that it is meant otherwise.

It will be appreciated that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. The same reference numbers may be used to describe like or similar parts. Further, while several examples have been disclosed herein, any features from any examples may be combined with or replaced by other features from other examples. Moreover, while several examples have been disclosed herein, changes may be made to the disclosed examples within departing from the scope of the claims.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A method for producing a decorative mobile device case comprising:
uploading a graphic image to a digital printing software application;
depositing at least one ink layer on a first side of a transparent substrate, wherein the at least one ink layer corresponds to the digital image; and
inserting, after said depositing the at least one ink layer, the transparent substrate between a mobile electronic device and the decorative mobile device case.

2. The method of claim 1, further comprising:
defining at least one opacity enhancing layer using said digital printing application; and
forming, using said digital printing application, a composite image comprised of said graphic image and said at least one opacity enhancing layer,
wherein said depositing comprises depositing the at least one ink layer where the at least one ink layer corresponds to the composite image.

3. The method of claim 2, wherein depositing the at least one ink layer comprises:
depositing, on the transparent substrate, a first ink layer corresponding to the graphic image; and
depositing, on the transparent substrate after the first ink layer, a second ink layer corresponding to a first of the at least one opacity enhancing layers.

4. The method of claim 3, wherein depositing the at least one ink layer further comprises depositing, on the transparent substrate after the second ink layer, a third ink layer corresponding to a second of the at least one opacity enhancing layers.

5. The method of claim 1, further comprising forming a reverse of the digital image using said digital image software application prior to said depositing the at least one ink layer.

6. The method of claim 2, wherein defining the at least one opacity enhancing layer using said digital printing application comprising defining the at least one opacity enhancing layer to overlay less than all of the graphic image.

7. The method of claim 6, wherein defining the at least one opacity enhancing layer to overlay less than all of the graphic image comprising defining the at least one opacity enhancing layer with a reduced border as compared to a border of the graphic image.

8. The method of claim 1, wherein depositing the at least one ink layer comprises depositing the at least one ink layer using an ultraviolet (UV) inkjet digital printing process.

9. The method of claim 8, wherein the UV inkjet digital printing process comprising spraying ink droplets onto the first side of the transparent substrate so as to form a layer of ink that has a smooth side formed against the first side of the transparent substrate and a relatively rough side opposite to the smooth side.

10. A method for producing a decorative mobile device case comprising:
uploading a graphic image to a digital printing software application;
depositing at least one ink layer on a first side of a transparent substrate, wherein the at least one ink layer corresponds to the digital image; and
attaching, after said depositing the at least one ink layer, the first side of the transparent substrate to an exterior of the decorative mobile device case.

11. The method of claim 10, further comprising:
defining at least one opacity enhancing layer using said digital printing application; and
forming, using said digital printing application, a composite image comprised of said graphic image and said at least one opacity enhancing layer,
wherein said depositing comprises depositing the at least one ink layer where the at least one ink layer corresponds to the composite image.

12. The method of claim 10, wherein attaching the transparent substrate to the decorative mobile device case comprises attaching, after said depositing the at least one ink layer, the first side of the transparent substrate to the exterior surface of the decorative mobile device case by at least one of a snap-fit coupling, a mechanical binding, a magnetic coupling, and an adhesive.

13. The method of claim 10, wherein attaching the transparent substrate to the decorative mobile device case comprises attaching, after said depositing the at least one ink layer, the first side of the transparent substrate to a bumper of the decorative mobile device case by at least one of a snap-fit coupling, a mechanical binding, a magnetic coupling, and an adhesive.

14. The method of claim 13, wherein the transparent substrate forms at least a portion of a back side of the decorative mobile device case.

15. The method of claim 11, wherein depositing the at least one ink layer comprises:
depositing, on the transparent substrate, a first ink layer corresponding to the graphic image; and
depositing, on the transparent substrate after the first ink layer, a second ink layer corresponding to a first of the at least one opacity enhancing layers.

16. The method of claim 15, wherein depositing the at least one ink layer further comprises depositing, on the transparent substrate after the second ink layer, a third ink layer corresponding to a second of the at least one opacity enhancing layers.

17. The method of claim 10, further comprising forming a reverse of the digital image using said digital image software application prior to said depositing the at least one ink layer.

18. The method of claim 11, wherein defining the at least one opacity enhancing layer using said digital printing application comprising defining the at least one opacity enhancing layer to overlay less than all of the graphic image.

19. The method of claim 18, wherein defining the at least one opacity enhancing layer to overlay less than all of the graphic image comprising defining the at least one opacity enhancing layer with a reduced border as compared to a border of the graphic image.

20. The method of claim 10, wherein depositing the at least one ink layer comprises depositing the at least one ink layer using an ultraviolet (UV) inkjet digital printing process.

21. The method of claim 20, wherein the UV inkjet digital printing process comprising spraying ink droplets onto the first side of the transparent substrate so as to form a layer of ink that has a smooth side formed against the first side of the transparent substrate and a relatively rough side opposite to the smooth side.
